(19) United States
(12) Patent Application Publication
(10) Pub. No.: US 2014/0253519 A1
(43) Pub. Date: Sep. 11, 2014

(54) EXPANDABLE DIAMETER STYLUS

(71) Applicants: Michael David, Austin, TX (US); Sean P. O'Neal, Austin, TX (US)

(72) Inventors: Michael David, Austin, TX (US); Sean P. O'Neal, Austin, TX (US)

(21) Appl. No.: 13/789,898

(22) Filed: Mar. 8, 2013

(51) Int. Cl. G06F 3/0354

(52) U.S. Cl. CPC G06F 3/03545
USPC 345/179

(57) ABSTRACT

In accordance with the present disclosure, an expandable diameter stylus and related systems and methods are described herein. The expandable diameter stylus may comprise an elongated body and a writing surface disposed on an end of the elongated body. The expandable diameter stylus may also include a variable diameter grip proximate to the writing surface. In certain embodiments the variable diameter grip may have a first diameter when the expandable diameter stylus is positioned within a stylus garage of a portable computing system. The variable diameter grip may have a second diameter, larger than the first diameter, when the stylus is removed from the stylus garage for use as an input device.

### TECHNICAL FIELD

The present disclosure relates generally to the operation of computer systems and information handling systems, and, more particularly, to an expandable diameter stylus.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

Some portable information handling systems—including tablets, notebook computers, and smartphones—utilize a pen or stylus as an input device. The terms pen and stylus may be used interchangeably herein. Typically the stylus is sorted in a garage on the system, so that a user has access to the stylus when desired and can safely store it when it is not in use. Unfortunately, with portability an important factor in tablet and notebook design, the profile of tablets and notebooks has been decreasing, limiting the space available for the garage and the stylus. Stylus input devices also are likely to decrease in size at the expense of usability and user comfort.

### SUMMARY

In accordance with the present disclosure, an expandable diameter stylus and related systems and methods are described herein. The expandable diameter stylus may comprise an elongated body and a writing surface disposed on an end of the elongated body. The expandable diameter stylus may also include a variable diameter grip proximate to the writing surface. In certain embodiments the variable diameter grip may have a first diameter when the expandable diameter stylus is positioned within a stylus garage of a portable computing system. The variable diameter grip may have a second diameter, larger than the first diameter, when the stylus is removed from the stylus garage for use as an input device.

The system and method disclosed herein is technically advantageous because it allows for a stylus device to be stored with a portable computing system while still allowing for an optimal diameter for use. Notably, the various diameters which the stylus may take may be changed as the profile of portable computing devices change. This may allow for a stylus that can be scaled to the profile of any portable computing device, while still providing user conformability. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of an existing portable computing system.

FIGS. 2A-2C are diagrams of an example expandable diameter stylus, according to aspects of the present disclosure.

FIGS. 3A and 3B are diagram of an example expandable diameter stylus, according to aspects of the present disclosure.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

Illustrative embodiments of the present disclosure are described in detail herein. In the interest of clarity, not all features of an actual implementation may be described in this specification. It will of course be appreciated that in the development of any such actual embodiment, numerous implementation-specific decisions must be made to achieve the specific implementation goals, which will vary from one implementation to another. Moreover, it will be appreciated that such a development effort might be complex and time-consuming, but would nevertheless be a routine undertaking for those of ordinary skill in the art having the benefit of the present disclosure.

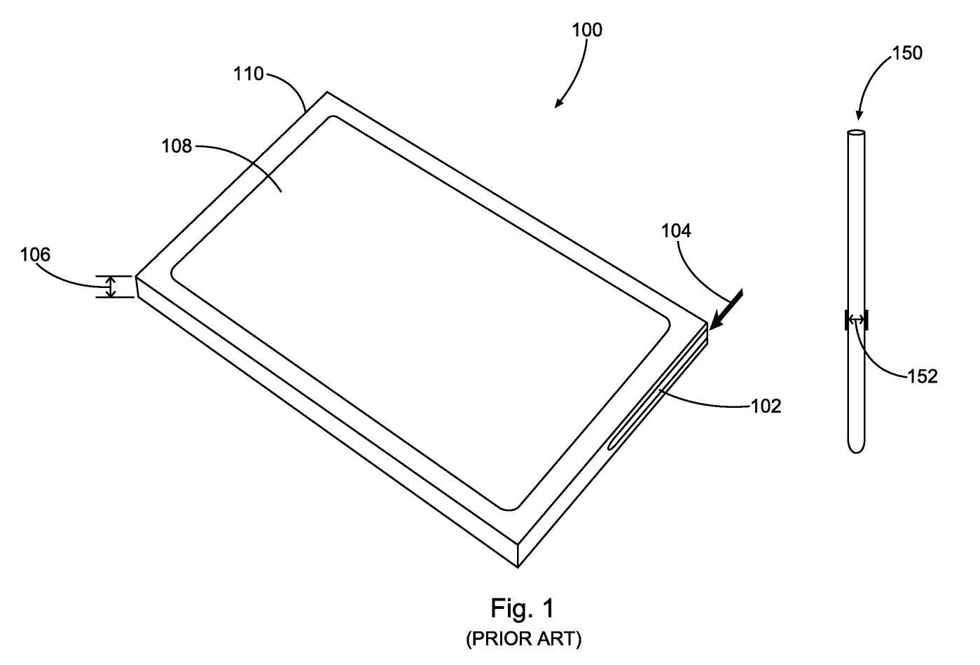

Shown in FIG. 1 is a diagram of a typical portable computing system or information handling system 100. As used herein, the terms computing system, computing device, and information handling system may be used interchangeably. A portable computing system may comprise a computing system that is intended for use away from a fixed location, including but not limited to a notebook computer, a tablet computer, and a smartphone, i.e. a mobile phone with a mobile operating system. The portable computing system 100 may include a frame 110 positioned around a screen 108. The screen 108 may be touch-sensitive or otherwise respond to a stylus input device 150. The frame 110 may include a hollow portion or garage 102 in which the stylus 150 may be stored. As will be appreciated by one of ordinary skill in view of this disclosure, the diameter of the garage 102 may be limited by the thickness 106 of the portable computing system 100.

Portable computing systems like portable computing system 100 have been trending toward a smaller thickness 106 to increase portability. Future thicknesses of five millimeters are possible. Given the space limitations, the diameter 152 of the stylus 150 may also be reduced. With the optimal diameter of a writing instrument being around eight to nine millimeters, reducing the diameter to five millimeters will likely come at the expense of usability and comfortability.

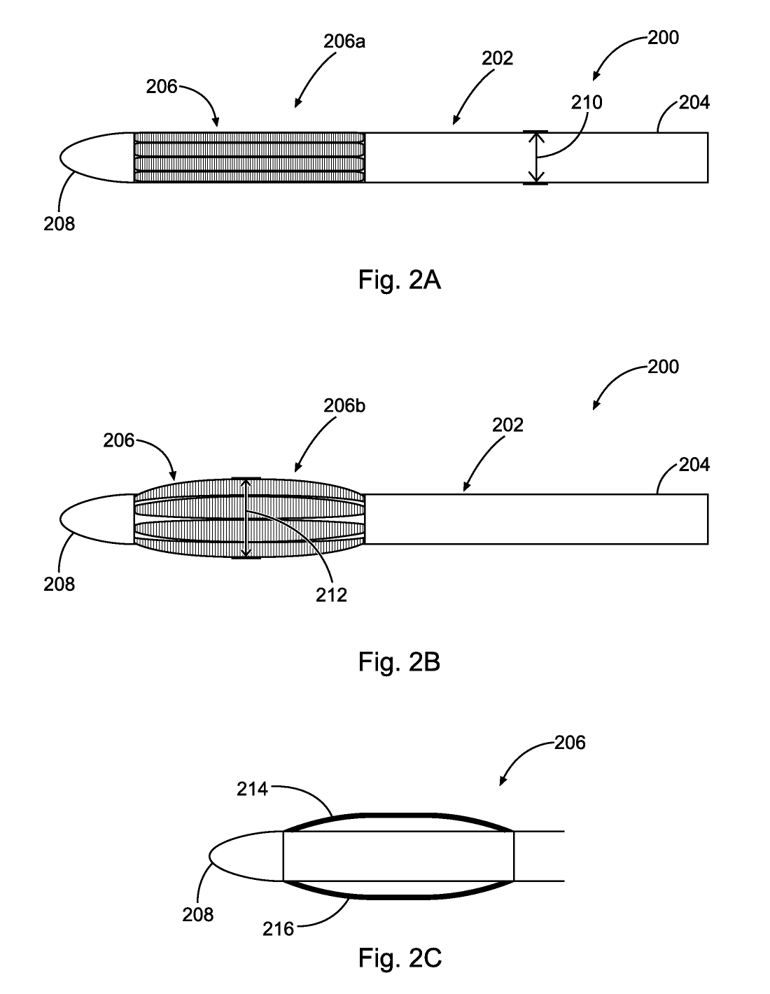

According to aspects of the present disclosure, an expandable diameter stylus is disclosed herein. As will be appreciated by one of ordinary skill in the art, the expandable diameter of the stylus may accommodate the narrower profile of portable computer while still allowing comfortable use with the portable computing system. FIGS. 2A, 2B, and 2C are diagrams illustrating an expandable diameter stylus 200 according to aspects of the present disclosure. The stylus 200 may comprise an elongated body 202. The elongated body 202 may comprise a fixed diameter portion 204 and a variable diameter portion 206. In certain embodiments the elongated body 202 may comprise a unitary piece, with the fixed diameter portion 204 and the variable diameter portion 206 formed as an integral element. In certain other embodiments, the fixed diameter portion 204 and the variable diameter portion 206 may be manufactured as at least two separate pieces that can be coupled together, such as by a threaded connection.

The stylus 200 may further comprise a writing surface 208 disposed on an end of the elongated body 202. The writing surface 208 may be, for example, formed integrally with the elongated body 202, or manufactured separately and coupled to the elongated body 202. In the embodiment shown, the writing surface 208 is disposed at an end of the elongated body 202 proximate to the variable diameter portion 206. The writing surface 208 may comprise a soft foam-type material to protect the screen of a portable computing device. Other materials may also be used, as will be appreciated by one of ordinary skill in view of this disclosure.

In the embodiment shown, the variable diameter portion 206 comprises a variable diameter grip. The grip may be positioned proximate to the writing surface 208. The fixed diameter portion 204 may have a first diameter 210, and the variable diameter portion 206 may expand from the first diameter 210 to a second diameter 212, larger than the first diameter 210. Although two diameters are shown, an expandable diameter stylus may have a plurality of diameters within the scope of this disclosure, and the embodiments shown are not limited to only two diameters. FIG. 2A shows the variable diameter grip 206 in a first position 206a, where the diameter of the variable diameter grip 206 is the first diameter 210, substantially the same as the fixed diameter portion 204. In contrast, FIG. 2B shown the variable diameter grip 206 in a second position 206b, where the diameter of the variable diameter grip is a second diameter 212, larger than the first diameter 210.

In certain embodiments, the variable diameter grip 206 may comprise a rubberized covering disposed around a spring element 214 that may be configured to place the variable diameter grip in the first position 206a or the second position 206b, depending on the exterior forces applied to the variable diameter grip 206. Other spring elements may be configured to place the variable diameter grip 206 in a plurality of positions with a plurality of possible diameters. The spring element 214 may be in a compressed state when the variable diameter grip 206 is in the first position 206a and has the first diameter 210, and may be in an expanded position when the variable diameter portion 206 is in the second position 206b and has the second diameter. For example, the spring element 214 may comprise at least one leaf spring 216. In the embodiment shown, the spring element 214 comprises a plurality of leaf springs spaced radially around the elongated body 202. The leaf spring 216 may curve outwards from the elongated body 202 when relaxed, or not compressed, and may lay flat against the elongated body 202 when the leaf spring is compressed.

In certain embodiments, the spring element 214 may be compressed when the stylus 200 is inserted into a garage within a portable computing system, such as portable computing system 100 in FIG. 1. The force required to insert the stylus 200 in the garage combined with the narrow diameter of the garage may impart a compressive force of the variable diameter grip 206, causing the spring element 214 to compress and the variable diameter grip 206 to be placed in first position 206a with the first diameter 210. When compressed, the entire elongated body 202 may have the same diameter and may fit within the narrow diameter garage. Conversely, when the stylus 200 is removed from the garage, the compressive force may be removed, allowing the spring element 214 to expand into the second position 206b with the second diameter 210. Accordingly, the stylus 200 may have a diameter larger than a garage when the stylus 200 is removed for use, but may still fit within the garage for storage with a portable computing system when not in use.

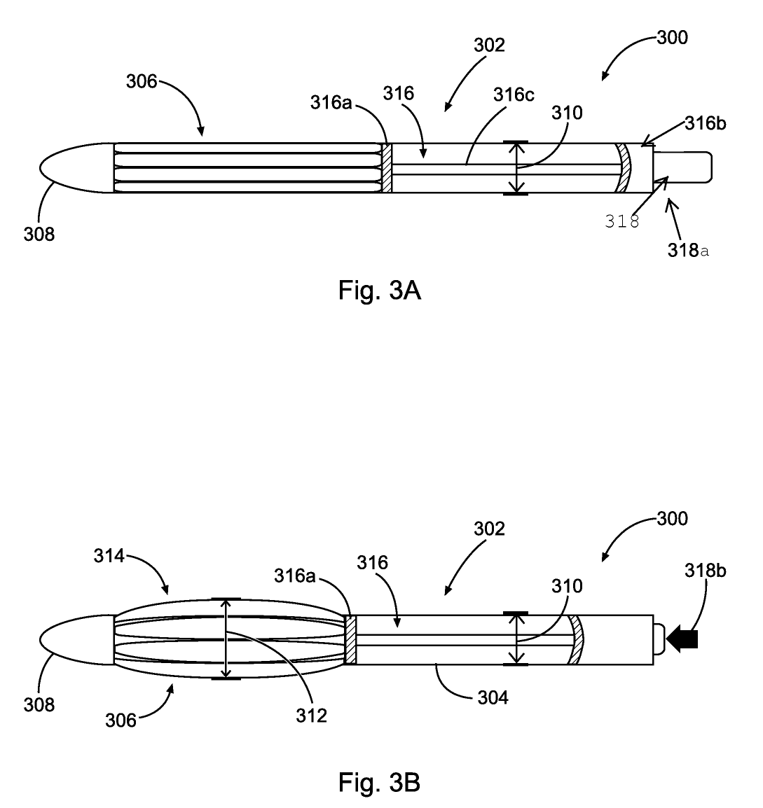

As will be appreciated by one of ordinary skill in the art in view of this disclosure, the stylus shown in FIGS. 2A-2C may expand automatically when removed from the garage. In certain embodiments, however, an expandable diameter stylus may be expanded manually. FIGS. 3A and 3B illustrate an example expandable diameter stylus 300 that may be manually expanded, without compressive forces from a garage. The stylus 300 may comprise an elongated body 302. The elongated body 302 may comprise a fixed diameter portion 304 and a variable diameter portion 306. In certain embodiments, the elongated body 302 may comprise a unitary piece, with the fixed diameter portion 304 and the variable diameter portion 306 formed as an integral element. In certain other embodiments, the fixed diameter portion 304 and the variable diameter portion 306 may be manufactured as at least two separate pieces that can be coupled together, such as by a threaded connection.

The stylus 300 may further comprise a writing surface 308 disposed on an end of the elongated body 302. The writing surface 308 may be, for example, formed integrally with the elongated body 302, or manufactured separately and coupled to the elongated body 302. In the embodiment shown, the writing surface 308 is disposed at an end of the elongated body 202 proximate to the variable diameter portion 306. The writing surface 308 may comprise a soft foam-type material to protect the screen of a tablet-like portable computing device. Other materials may also be used, as will be appreciated by one of ordinary skill in view of this disclosure.

In the embodiment shown, the variable diameter portion 306 comprises a variable diameter grip. The grip may be positioned proximate to the writing surface 308. The fixed diameter portion 304 may have a first diameter 310, and the variable diameter portion 306 may expand from the first diameter 310 to a second diameter 312, larger than the first diameter 310. FIG. 3A shows the variable diameter grip 306 in a first position 306a, where the diameter of the variable diameter grip 306 is the first diameter 310, substantially the same as the fixed diameter portion 304. In contrast, FIG. 3B shown the variable diameter grip 306 in a second position 306b, where the diameter of the variable diameter grip is a second diameter 312, larger than the first diameter 310.

In certain embodiments, the variable diameter grip 306 may comprise a spring element 314 that may be configured to place the variable diameter grip in the first position 306a or the second position 306b, or a plurality of other diameters depending on the configuration. The spring element 314 may comprise at least one plastic strip that is not compressed when the variable diameter portion 306 is in a first position 306a and is compressed with the variable diameter portion 306 is in a second position 206b. In the embodiment shown, the variable diameter portion 306 comprises a plurality of plastic strips radially spaced around the elongated body 302. The plastic strips may be positioned proximate to a locking mechanism 316. Specifically, the locking mechanism 316 may include a plunger 316a coupled to cam structure 316b via shaft 316c. The locking mechanism may be externally actuated by button 318 disposed on an end of the elongated body 302.

Unlike stylus 200, where a compressive force from a garage in a portable computer may cause the diameter of the variable diameter portion to change, the diameter of the variable diameter grip 306 may be altered using the locking mechanism 316. Specifically, when the button 318 is in position 318a, the locking mechanism 316 may be unlocked, the plastic strips may be in a relaxed state, and the variable diameter portion 306 may have the first diameter 310, substantially the same as the fixed diameter portion 302. In contrast, when the button 318 is in position 318b, the locking mechanism 316 may be locked, the plastic strips may be in a compressed state, and the variable diameter portion 306 may have the second diameter 312. Notably, by pressing the button 318 toward the elongated body 302, the locking mechanism 316 may be toggled between an unlocked state and a locked state. Accordingly, a user may manually select the diameter of the expandable diameter stylus.

Although the styluses described above include a variable diameter portion, other embodiments are possible within the scope of this disclosure. For example, in certain embodiments, the diameter of the entire stylus may expand together, without a fixed diameter portions. Additionally, other spring elements may be used, as can other elements used to manually select the diameter of the expandable diameter stylus. Likewise, in certain embodiments, the expandable diameter stylus may have varying degrees of diameter expansion, controlled by the user—so that the diameter can be set to whatever is comfortable according to individual preference.

According to aspects of the present disclosure, a method for providing an input device for a portable computing system is described herein. The method may include, providing a portable computing system, wherein the portable computing system includes a stylus garage. The portable computing system and stylus garage may be similar to those described above with respect to FIG. 1. The method may also include providing an expandable diameter stylus. As is also described above, the expandable diameter stylus may be configured to have a first diameter when the expandable diameter stylus is positioned within the stylus garage, and have a second diameter, larger than the first diameter, when the expandable diameter stylus is outside of the garage. The second diameter may be larger than the first diameter, and the expandable diameter stylus may expand to the second diameter either automatically or manually when the stylus is removed from the garage. The second diameter may be one of a plurality of diameters of the expandable diameter pen, either pre-set by the expansion mechanism of the stylus, or selectable by a user according to individual preference.

According to aspects of the present disclosure, a system comprising a portable computing device is also disclosed herein. The system may further include a stylus garage disposed within the portable computing device. Additionally, the system may include an expandable diameter stylus similar to those described above. The expandable diameter stylus may be configured to have a first diameter when the expandable diameter stylus is positioned within the garage and a second diameter when the expandable diameter stylus is positioned outside of the garage. The second diameter may be larger than the first diameter, and the expandable diameter stylus may expand to the second diameter either automatically or manually when the stylus is removed from the garage.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Although the present disclosure has been described in detail, it should be understood that various changes, substitutions, and alterations can be made hereto without departing from the spirit and the scope of the invention as defined by the appended claims. Also, the terms in the claims have their plain, ordinary meaning unless otherwise explicitly and clearly defined by the patentee. The indefinite articles “a” or “an,” as used in the claims, are defined herein to mean one or more than one of the element that it introduces.

What is claimed is:

1. An expandable diameter stylus comprising:
an elongated body;
a writing surface disposed on an end of the elongated body; and
a variable diameter grip proximate to the writing surface.

2. The expandable diameter stylus of claim 1, wherein the elongated body comprises a fixed diameter portion with a first diameter.

3. The expandable diameter stylus of claim 2, wherein the variable diameter grip comprises a spring element.

4. The expandable diameter stylus of claim 3, wherein the spring element is compressed when the variable diameter grip has the first diameter.

5. The expandable diameter stylus of claim 3, wherein the spring element is not compressed when the variable diameter grip has the first diameter.

6. The expandable diameter stylus of claim 3, wherein the variable diameter grip comprises at least one leaf spring.

7. The expandable diameter stylus of claim 3, further comprising a locking mechanism operatively coupled to the spring element.

8. The expandable diameter stylus of claim 7, wherein the spring element comprises a plastic strip.

9. The expandable diameter stylus of claim 7, wherein the variable diameter grip is configured to have a second diameter, larger than the first diameter, when the locking mechanism is in a locked position.

10. A method for providing an input device for a portable computing system, comprising:
providing the portable computing system, wherein the portable computing system includes a stylus garage;
providing an expandable diameter stylus, wherein the expandable diameter stylus is configured to
have a first diameter when the expandable diameter stylus is positioned within the stylus garage; and
have a second diameter, larger than the first diameter, when the expandable diameter stylus is outside of the garage.

11. The method of claim 10, wherein expandable diameter stylus comprises:
an elongated body;
a writing surface disposed on an end of the elongated body; and
a variable diameter grip proximate to the writing surface.

12. The method of claim 11, wherein the variable diameter grip comprises a spring element.

13. The method of claim 12, wherein the spring element is compressed when the variable diameter grip has the first diameter.

14. The method of claim 12, wherein the spring element is not compressed when the variable diameter grip has the first diameter.

15. The method of claim 12, wherein the variable diameter grip comprises at least one leaf spring.

16. The method of claim 12, further comprising a lockable plunger operatively coupled to the spring element.

17. The method of claim 16, wherein the spring element comprises at least one plastic strip.

18. A system comprising:
a portable computing device;
a stylus garage disposed within the portable computing device;
an expandable diameter stylus, wherein the expandable diameter stylus is configured to have a first diameter when the expandable diameter stylus is positioned within the garage and a second diameter when the expandable diameter stylus is positioned outside of the garage.

19. The system of claim 18, wherein the expandable diameter stylus is configured to automatically expand to the second diameter when removed from the garage.

20. The system of claim 18, wherein the expandable diameter stylus is configured to be manually expanded to the second diameter when removed from the garage.
